(19) United States
(12) Patent Application Publication
(10) Pub. No.: US 2026/0195060 A1
(43) Pub. Date: Jul. 9, 2026

(54) ELECTRONIC SYSTEM AND METHOD OF COMPRESSING SORTED STRING TABLES

(71) Applicant: Samsung Electronics Co., Ltd., Suwon-si (KR)

(72) Inventors: Junyeong Han, Suwon-si (KR); Youngjae Kim, Seoul (KR); Seongjin Byeon, Seoul (KR); Joseph Ro, Seoul (KR); Jeong Uk Kang, Suwon-si (KR)

(73) Assignee: SOGANG UNIVERSITY RESEARCH & BUSINESS DEVELOPMENT FOUNDATION, Seoul (KR)

(21) Appl. No.: 19/225,999

(22) Filed: Jun. 2, 2025

(30) Foreign Application Priority Data
Jan. 9, 2025 (KR) 10-2025-0003502

(51) Int. Cl. G06F 3/06

(52) U.S. Cl. CPC G06F 3/0638; G06F 3/0608; G06F 3/0679

(57) ABSTRACT

An electronic system includes a storage device and a host. The storage device includes multiple zones configured to store multiple sorted string tables (SSTs). The host is configured to: determine a first compression candidate group including a first SST and a first overlapping SST among the multiple SSTs, and a second compression candidate group including a second SST and a second overlapping SST among the multiple SSTs; and perform (i) zone-based compression operations for the first compression candidate group, determined based on the invalidation rate of the zones where the first and second compression candidate groups are stored and based on the free space of the storage device, or (ii) size-based compression operations for the second compression candidate group, determined based on the size of the first SST and the second SST.

### CROSS-REFERENCE TO RELATED APPLICATION

This application claims priority to Korean Patent Application No. 10-2025-0003502, filed with the Korean Intellectual Property Office on Jan. 9, 2025, the disclosure of which is incorporated herein by reference in its entirety.

### BACKGROUND

As the volume of data processed and stored continues to grow, and as the number of applications utilizing such data increases, storage systems may evolve to support efficient data organization and management. Advances in storage device architectures may have enabled new approaches to handling data layout, movement, and optimization within storage devices. Such developments may reinforce system performance and resource utilization across a wide range of computing environments.

### SUMMARY

A ZNS (Zone NameSpace) storage device may store multiple SSTs (Sorted String Tables) in the form of an LSM (Log Structured Merge)-tree. The host controlling the ZNS storage device may perform a compaction operation that excludes duplicate keys contained in the multiple SSTs and may generate compacted SSTs corresponding to the result of the compaction operation. Among the SSTs stored in one zone of the ZNS storage device, those that have been subject to the compaction operation may be set as invalid SSTs, and among the SSTs stored in one zone, the valid SSTs, excluding the invalid SSTs, may be copied to another zone during a garbage collection operation.

Implementations according to this disclosure provide an electronic system that can increase the efficiency of compression operations, which compress SSTs (Sorted String Tables) based on the free space of a storage device.

An electronic system according to some implementations includes a storage device including multiple zones configured to store multiple SSTs (Sorted String Tables), and A host configured to determine a first compression candidate group including a first SST and a first overlapping SST among the multiple SSTs, and a second compression candidate group including a second SST and a second overlapping SST among the multiple SSTs, perform zone-based compression operations for the first compression candidate group, determined based on the invalidation rate of the zones where the first and second compression candidate groups are stored, based on the free space of the storage device, or size-based compression operations for the second compression candidate group, determined based on the size of the first SST and the second SST.

An electronic system according to some implementations includes a storage device including multiple zones configured to store multiple SSTs level groups containing multiple SSTs (Sorted String Tables), and A host configured to a first level SST group with a size greater than the critical size among the multiple of SST level groups, determine a plurality of compression candidate groups including first SSTs included in the first level SST group and the overlapping SSTs included in the second level SST group among the multiple of SST level groups, and perform a zone-based compression operation for a first compression candidate group, which is determined based on the invalidation rate of the plurality of zones where the plurality of compression candidate groups are stored, or a size-based compression operation for a second compression candidate group, which is determined based on the size of the first SSTs among the plurality of compression candidate groups based on the level of the first level SST group.

A method of compressing SST according to some implementations includes determining a first level SST group of a size larger than the threshold size among multiple SSTs level groups containing multiple SSTs (Sorted String Tables), determining a plurality of compression candidate groups including first SSTs included in the first level SST group and overlapping SSTs included in the second level SST group among the multiple of SST level groups, selecting a first compression candidate group determined based on the invalidation ratio of the multiple zones where multiple compression candidate groups are stored, or a second compression candidate group determined based on the size of the first SSTs among the multiple compression candidate groups based on a free space of the storage device, and performing a compression operation on the first compression candidate group or the second compression candidate group based on the free space of the storage device.

### BRIEF DESCRIPTION OF THE DRAWINGS

FIG. 1 is a diagram illustrating an example of an electronic system that includes a storage device and a host.

FIG. 2 is a diagram illustrating an example of a host that can generate an SST (Sorted String Table).

FIG. 3 is a diagram illustrating an example of a host that can perform a compression operation based on the free space of a storage device.

FIG. 4 is a diagram illustrating an example of SST level groups that include SSTs.

FIG. 5 is a diagram illustrating an example of a size-based compression operation.

FIG. 6 is a diagram illustrating an example of a garbage collection operation that can be conducted according to a size-based compression operation.

FIG. 7 is a diagram illustrating an example of a zone-based compression operation.

FIG. 8 is a diagram illustrating an example of a host that can select one of compression candidate groups based on invalidation rates of a plurality of zones.

FIG. 9 is a diagram illustrating an example of a garbage collection operation that can be conducted according to a zone-based compression.

FIG. 10 is a diagram illustrating an example of a host that can perform size-based compression operations based on a level of an SST level group being greater than a threshold size.

FIG. 11 is a diagram illustrating an example of a host that can perform zone-based compression operations based on a level of an SST level group being greater than a critical size.

FIG. 12 is a flowchart of an example of an electronic system that can perform size-based compression operation or zone-based compression operation.

FIG. 13 is a diagram illustrating an example of a non-volatile memory device.

FIG. 14 is a diagram illustrating an example of a storage controller.

FIG. 15 is a diagram illustrating an example of a system that includes a storage device.

### DETAILED DESCRIPTION

Hereinafter, with reference to the attached drawings, various implementations of the present invention will be described in detail so that those skilled in the art to which the present invention pertains can easily implement them. The present invention can be embodied in various different forms and is not limited to the implementations described herein.

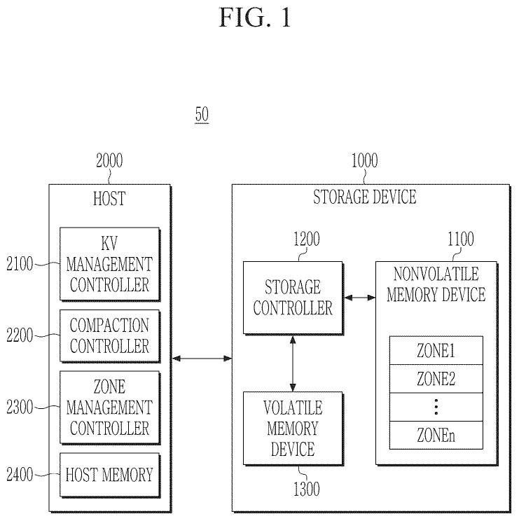

FIG. 1 is a diagram illustrating an example of an electronic system that includes a storage device and a host.

Referring to FIG. 1, the electronic system 50 can include a storage device 1000 and a host device 2000.

In some implementations, the storage device 1000 can be a device that stores data under the control of the host device 2000. In some implementations, the storage device 1000 can be manufactured in the form of an SSD (Solid State Drive) or UFS (Universal Flash Storage).

In some implementations, the storage device 1000 can include a non-volatile memory device 1100, a storage controller 1200, and a volatile memory device 1300.

In some examples, the non-volatile memory device 1100 can store data. The non-volatile memory device 1100 can operate in response to the control of the storage controller 1200. In some implementations, the non-volatile memory device 1100 can be a NAND flash memory. In some implementations, the non-volatile memory device 1100 can include multiple zones ZONE1~ZONEn. In some implementations, the multiple zones ZONE1~ZONEn can be areas corresponding to multiple logical address groups provided by the host device 2000. In some implementations, the multiple logical address groups can correspond to multiple applications executed by the host device 2000. In some implementations, the multiple zones ZONE1~ZONEn can each include multiple memory blocks. In some implementations, the multiple memory blocks can each include multiple memory cells that store data.

In some implementations, the non-volatile memory device 1100 can receive commands and addresses from the storage controller 1200 and perform operations as directed by the commands on the area selected by the address. The non-volatile memory device 1100 can perform a program operation (write operation) that stores data in the area selected by the address, a read operation that reads data, or an erase operation that deletes data.

In some implementations, the storage controller 1200 can control the overall operation of the storage device 1000.

In some implementations, the storage controller 1200 can execute firmware when power is applied to the storage device 1000. The firmware can include a host interface layer that controls communication with the host device 2000, a flash translation layer that controls communication between the host device 2000 and the non-volatile memory device 1100, and a memory interface layer that controls communication with the non-volatile memory device 1100. In some implementations, the flash translation layer can convert the logical address of the host device 2000 to the physical address of the non-volatile memory device 1100.

In some implementations, the storage controller 1200 can control the non-volatile memory device 1100 to perform write operations, read operations, or erase operations in response to requests from the host device 2000. During a write operation, the storage controller 1200 can provide a write command, address, and data to the non-volatile memory device 1100. During a read operation, the storage controller 1200 can provide a read command and address to the non-volatile memory device 1100. During an erase operation, the storage controller 1200 can provide an erase command and address to the non-volatile memory device 1100.

In some implementations, the volatile memory device 1300 can temporarily store data provided from the host device 2000 or temporarily store data read from the non-volatile memory device 1100. In some implementations, the volatile memory device 1300 can be dynamic random access memory (DRAM) or static random access memory (SRAM).

In some implementations, the host device 2000 can communicate with the storage device 1000 using interfaces such as NVMe (Non-Volatile Memory express), UFS (Universal Flash Storage), PCIe (Peripheral Component Interconnect express), USB (Universal Serial Bus), DDR (Double Data Rate), LPDDR (Low Power DDR), SATA (Serial Advanced Technology Attachment), and SCSI (Small Computer System Interface).

In some implementations, the host device 2000 can include a key-value management controller 2100, a compression controller 2200, a zone management controller 2300, and host memory 2400.

In some implementations, the key-value management controller 2100 can generate a key and a value corresponding to the key. In some implementations, the key-value management controller 2100 can store key-value pairs, which include a key and a value corresponding to the key, in the host memory 2400. In some implementations, if the size of multiple key-value pairs stored in the host memory 2400 is larger than a preset size, the key-value management controller 2100 can generate an SST (Sorted String Table) that sorts the key-value pairs based on the key.

In some implementations, the compression controller 2200 can perform a compression operation that compresses multiple SSTs. In some implementations, the compression operation can be an operation that generates compressed SSTs containing key-value pairs excluding duplicate keys among the multiple key-value pairs included in the multiple SSTs.

In some implementations, the compression controller 2200 can determine a target SST level group larger than a threshold size among multiple SSTs level groups that include multiple SSTs. In some implementations, the compression controller 2200 can determine overlapping SSTs that are included in other SST level groups and contain keys overlapping with the keys included in the target SSTs within the target SST level group.

In some implementations, the compression controller 2200 can determine a plurality of compression candidate groups that include target SSTs contained in a target SST level group and overlapping SSTs contained in other SST level groups. In some implementations, the compression controller 2200 can perform a compression operation on the target SST and overlapping SST included in one of the plurality of compression candidate groups. In some implementations, the compression controller 2200 can generate compressed SSTs corresponding to the results of the compression operation.

In some implementations, the compression operation can include a size-based compression operation and a zone-based compression operation. In some implementations, the compression controller 2200 can selectively perform a size-based compression operation or a zone-based compression operation based on the free space of the storage device 1000.

In some implementations, the size-based compression operation can be a compression operation for one compression candidate group determined based on the sizes of target SSTs included in the target SST level group among multiple compression candidate groups.

In some implementations, the zone-based compression operation can be a compression operation for another compression candidate group determined based on the invalidation rate of a plurality of zones in which a plurality of compression candidate groups are stored.

In some implementations, the compression controller 2200 can selectively perform size-based compression operations or zone-based compression operations based on the level of the target SST level group, which is larger than the threshold size among multiple SSTs level groups.

In some implementations, the zone management controller 2300 can control operations for multiple zones. In some implementations, the zone management controller 2300 can set data stored in multiple zones as invalid data. In some implementations, the zone management controller 2300 can control the storage device 1000 to perform a garbage collection operation (or zone cleaning operation) that copies valid data stored in one of the multiple zones to another zone. In some implementations, after performing the garbage collection operation, the zone management controller 2300 can provide a zone reset command to the storage device 1000 to erase the data stored in one zone.

In some implementations, the host memory 2400 can temporarily store data generated by the host device 2000. In some implementations, the host memory 2400 can store a plurality of key-value pairs generated by the key-value management controller (2400).

In some implementations, the host memory 2400 can temporarily store data read from the storage device 1000. In some implementations, the host memory 2400 can temporarily store multiple SSTs read from the storage device 1000. In some implementations, the host memory 2400 can be volatile memory.

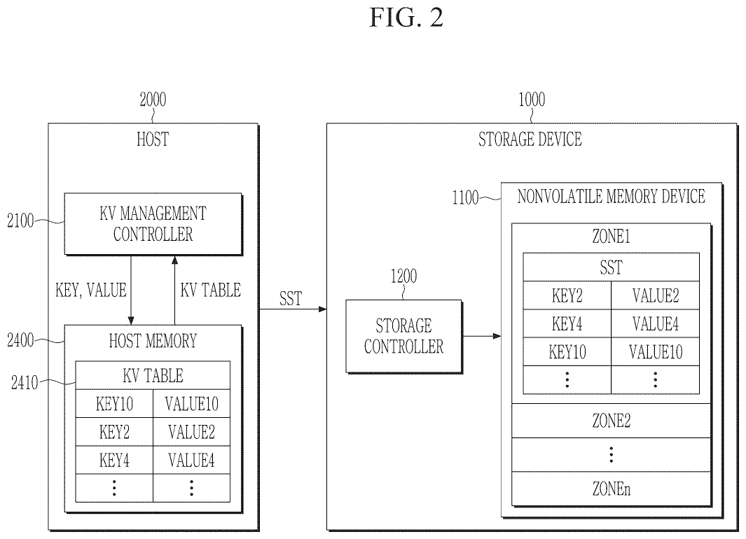

FIG. 2 is a diagram illustrating an example of a host that can generate an SST (Sorted String Table).

Referring to FIG. 2, the key-value management controller 2100 can generate a key-value table 2410 that includes a plurality of keys and a plurality of values corresponding to each of the plurality of keys, and provide the key-value table 2410 to the host memory 2400. In some implementations, the key-value management controller 2100 can generate the key-value table 2410 that includes a plurality of keys and a plurality of values sorted according to the order in which the plurality of keys were generated. In some implementations, the order of the plurality of keys included in the key-value table 2410 can be the order of a 10th key KEY 10, a 2nd key KEY 2, and a 4th key KEY 4.

In some implementations, the key-value management controller 2100 can generate an SST based on the key-value table 2410 if the size of the key-value table 2410 is larger than a threshold size. In some implementations, the key-value management controller 2100 can read the key-value table 2410 from the host memory 2400 and generate an SST that sorts multiple keys and multiple values based on the keys. In some implementations, the key-value management controller 2100 can generate an SST that arranges the order of multiple keys in the sequence of the second key KEY2, the fourth key KEY4, and the tenth key KEY10. In some implementations, the key-value management controller 2100 can provide the SST to the storage device 1000.

In some implementations, the storage device 1000 can store the SST received from the host device 2000 in a first zone ZONE1 among a plurality of zones ZONE1~ZONEn.

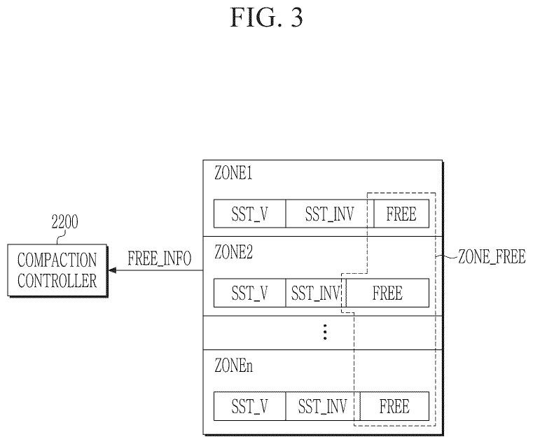

FIG. 3 is a diagram illustrating an example of a host that can perform a compression operation based on the free space of a storage device.

Referring to FIG. 3, multiple zones ZONE1~ZONEn can store valid SST SST_V and invalid SST SST_INV. In some implementations, the valid SST SST_V can be an SST that includes a valid key and a valid value. In some implementations, the invalid SST SST_INV can be an SST that includes an invalidated key and an invalidated value.

In some implementations, multiple zones ZONE1~ZONEn can include a free space ZONE_FREE excluding the space where valid SST SST_V and invalid SST SST_INV are stored. The free space ZONE_FREE of the multiple zones can be an area where data is not stored.

In some implementations, the compression controller 2200 receives information FREE_INFO regarding the free space of a plurality of zones from the storage device 1000 and can perform size-based compression operations or zone-based compression operations based on the free space ZONE_FREE of the plurality of zones.

In some implementations, the compression controller 2200 can perform a size-based compression operation if the size of the free space ZONE_FREE of multiple zones is greater than a preset size. In some implementations, the compression controller 2200 can perform a zone-based compression operation if the size of the free space ZONE_FREE of multiple zones is less than or equal to a preset size.

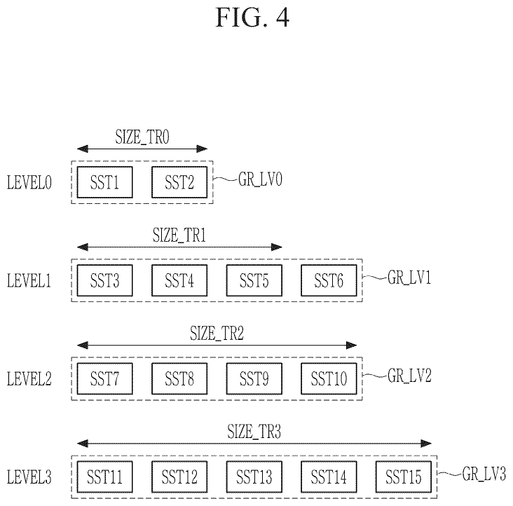

FIG. 4 is a diagram illustrating an example of SST level groups that include SSTs.

Referring to FIG. 4, multiple zones ZONE1~ZONEn can store multiple SSTs level group GR_LV0~GR_LV3 containing multiple SSTs SST1~SST15. In some implementations, the multiple SSTs SST1~SST15 can be configured into multiple SSTs level group GR_LV0~GR_LV3, each corresponding to multiple levels. The multiple SSTs level groups can include SSTs sorted by levels based on the LSM (Log Structured Merge)-Tree.

In some implementations, a Level 0 SST group GR_LV0 can correspond to Level 0 LEVEL0. In some implementations, the Level 0 SST group GR_LV0 can include the first SST SST1 and the second SST SST2. In some implementations, the threshold size of the Level 0 SST group GR_LV0 can be a Level 0 threshold size SIZE_TR0. In some implementations, if the size of the Level 0 SST group GR_LV0 is greater than the Level 0 threshold size SIZE_TR0, a compression operation can be performed on some SSTs of the Level 0 SST group GR_LV0.

In some implementations, a first level SST group GR_LV1 can correspond to the first level LEVEL1. In some implementations, the first level SST group GR_LV1 can include the third to sixth SST SST3~SST6. In some implementations, the threshold size of the first level SST group GR_LV1 can be a first threshold size SIZE_TR1 larger than the Level 0 threshold size SIZE_TR0. In some implementations, if the size of the first level SST group GR_LV1 is greater than the first threshold size SIZE_TR1, a compression operation can be performed on some SSTs of the first level SST group GR_LV1.

In some implementations, a second level SST group GR_LV2 can correspond to the second level LEVEL2. In some implementations, the second level SST group GR_LV2 can include the seventh to tenth SST SST7~SST10. In some implementations, the critical size of the second level SST group GR_LV2 can be a second threshold size SIZE_TR2 larger than the first threshold size SIZE_TR1. In some implementations, if the size of the second level SST group GR_LV2 is larger than the second threshold size SIZE_TR2, a compression operation can be performed on some SSTs of the second level SST group GR_LV2.

In some implementations, a third level SST group GR_LV3 can correspond to a third level LEVEL3. In some implementations, the third level SST group GR_LV3 can include the eleventh to fifteenth SST SST11~SST15. In some implementations, the threshold size of the third level SST group GR_LV3 can be a third threshold size SIZE_TR3 that is larger than the second threshold size SIZE_TR2. In some implementations, if the size of the third level SST group GR_LV3 is larger than the third threshold size SIZE_TR3, a compression operation can be performed on some SSTs of the third level SST group GR_LV3.

In some implementations, the compression controller 2200 can determine one SST level group among multiple SSTs level group GR_LV0~GR_LV3 as the target SST level group to perform the compression operation if the size of one SST level group is greater than the threshold size. In some implementations, the compression controller 2200 can determine the first level SST group GR_LV1 with a size greater than the first threshold size SIZE_TR1 among multiple SSTs level group GR_LV0~GR_LV3 as the target SST level group to perform the compression operation.

In some implementations, the compression controller 2200 can perform a size-based compression operation for a compression candidate group that includes one of the third to sixth SST SST3~SST6 included in the first level SST group GR_LV1 based on the free space of the storage device 1000, or perform a zone-based compression operation for a compression candidate group that includes another one of the third to sixth SST SST3~SST6.

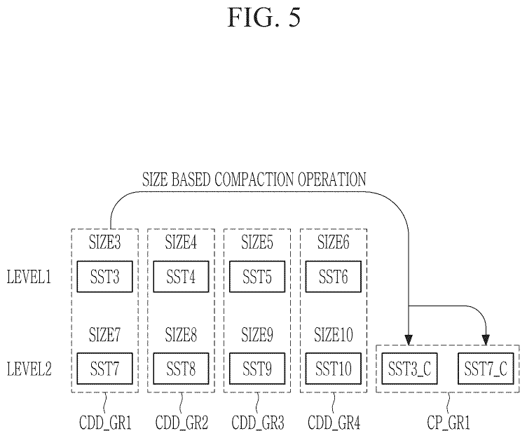

FIG. 5 is a diagram illustrating an example of a size-based compression operation.

Referring to FIGS. 4 and 5, the compression controller 2200 can perform a size-based compression operation if the size of the free space in the storage device 1000 is greater than a preset size.

In some implementations, the compression controller 2200 can determine a target level SST group with a size larger than the threshold size among multiple SSTs level groups. In some implementations, the compression controller 2200 can determine a first level SST group GR_LV1 with a size larger than the first threshold size SIZE_TR1 among multiple SSTs level groups.

In some implementations, the compression controller 2200 can be included in an SST level group higher than the level of the target level SST group, and it can determine overlapping SSTs that include keys overlapping with the keys contained in the target SSTs included in the target level SST group.

In some implementations, the seventh SST SST7 can include keys that overlap with the keys contained in a third SST SST3. In some implementations, the compression controller 2200 can determine the overlapping SST of the third SST SST3as the seventh SST SST7.

In some implementations, the eighth SST SST8 can include keys that overlap with those contained in the fourth SST SST4. In some implementations, the compression controller 2200 can determine the overlapping SST of the fourth SST SST4 as the eighth SST SST8.

In some implementations, the compression controller 2200 can determine multiple compression candidate groups that include target SSTs contained in the target level SST group and nested SSTs contained in SST level groups higher than the level of the target level SST group. In some implementations, the compression controller 2200 can determine a first compression candidate group CDD_GR1 that includes the third SST SST3 and the seventh SST SST7, a second compression candidate group CDD_GR2 that includes the fourth SST SST4 and the eighth SST SST8, a third compression candidate group CDD_GR3 that includes the fifth SST SST5 and the ninth SST SST9, and a fourth compression candidate group CDD_GR4 that includes the sixth SST SST6 and the tenth SST SST10.

In some implementations, the compression controller 2200 can select a compression candidate group to perform size-based compression operation based on the result of comparing the sizes of target SSTs included in the target level SST group.

In some implementations, the largest SST among the third to sixth SST SST3~SST6 included in the first level SST group GR_LV1 can be the third SST SST3. In some implementations, the compression controller 2200 can select the first compression candidate group CDD_GR1, which includes the largest third SST SST3 among the third to sixth SST SST3~SST6 included in the first level SST group GR_LV1, as the compression candidate group to perform size-based compression operations.

In some implementations, if the size of the third SST SST3 and the fourth SST SST4 included in the first level SST group GR_LV1 is the same, the compression controller 2200 can select a compression candidate group to perform size-based compression operation based on the result of comparing the sizes of the overlapping SSTs.

In some implementations, the size of the seventh SST SST7 can be smaller than the eighth SST SST8. In some implementations, if the sizes of the third SST SST3 and the fourth SST SST4 are the same, the compression controller 2200 can select the first compression candidate group CDD_GR1, which includes the smaller-sized seventh SST SST7 among the seventh SST SST7 and the eighth SST SST8, as the compression candidate group to perform size-based compression operations.

In some implementations, the compression controller 2200 can perform a size-based compression operation for the first compression candidate group CDD_GR1, which is determined based on the sizes of the third to sixth SST SST3~SST6 included in the first level SST group GR_LV1 among multiple compression candidate groups.

In some implementations, the compression controller 2200 can generate a compressed third SST SST3_C and a compressed seventh SST SST7_C by excluding duplicate keys among the keys included in the third SST SST3 and the seventh SST SST7. In some implementations, the compression controller 2200 can provide the compressed third SST SST3_C and the compressed seventh SST SST7_C to the storage device 1000.

In some implementations, the level of a first compression group CP_GR1, which includes the compressed third SST SST3_C and compressed seventh SST SST7_C, can correspond to the second level LEVEL2. The compressed third SST SST3_C and compressed seventh SST SST7_C can be included in the second level SST group GR_LV2.

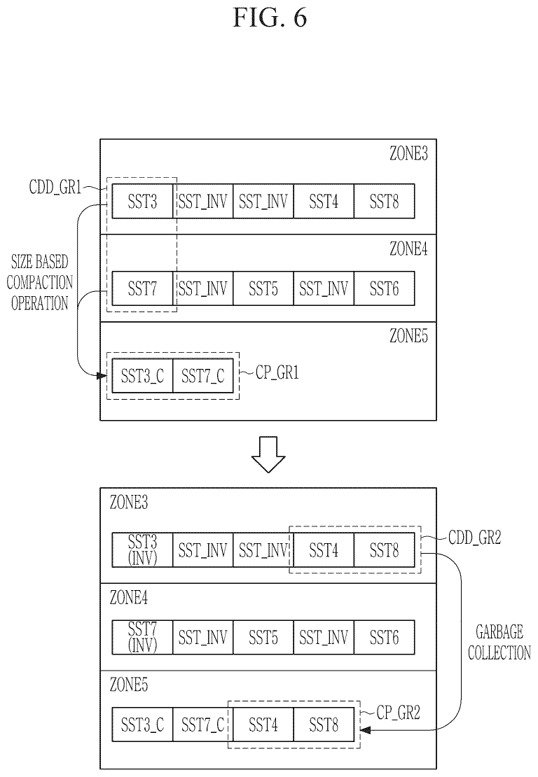

FIG. 6 is a diagram illustrating an example of a garbage collection operation that can be conducted according to a size-based compression operation.

Referring to FIG. 5 and FIG. 6, the third zone ZONE3 can store the third SST SST3, invalid SST SST_INV, fourth SST SST4, and eighth SST SST8. In some implementations, the fourth zone ZONE4 can store the seventh SST SST7, invalid SST SST_INV, fifth SST SST5, and sixth SST SST6.

In some implementations, if the size of the free space in the storage device 1000 is greater than a preset size, the compression controller 2200 can select the first compression candidate group CDD_GR1, which includes the third SST SST3 and the seventh SST SST7, from among multiple compression candidate groups, and perform a size-based compression operation on the first compression candidate group CDD_GR1.

In some implementations, the third SST SST3 and the seventh SST SST7 included in the first compression candidate group CDD_GR1 targeted for size-based compression operations can be stored in different zones. In some implementations, during the size-based compression operation, the compression controller 2200 compresses the third SST SST3 stored in the third zone ZONE3 and the seventh SST SST7 stored in the fourth zone ZONE4 to generate compressed third SST SST3_C and compressed seventh SST SST7_C, and can store the compressed third SST SST3_C and compressed seventh SST SST7_C in the fifth zone ZONE5.

In some implementations, after the size-based compression operation is performed on the first compression candidate group CDD_GR1, the zone management controller 2300 can set the third SST SST3 stored in the third zone ZONE3 and the seventh SST SST7 stored in the fourth zone ZONE4 as invalid data INV.

In some implementations, the zone management controller 2300 can perform a garbage collection operation for the third zone ZONE3 after the third SST SST3 and the seventh SST SST7 are set to invalid data INV. In some implementations, during the garbage collection operation, the zone management controller 2300 can copy the valid data, excluding the invalid data, stored in the third zone ZONE3 to the fifth zone ZONE5. In some implementations, the valid data stored in the third zone ZONE3 can be the fourth SST SST4 and the eighth SST SST8.

In some implementations, the zone management controller 2300 can copy the fourth SST SST4 and the eighth SST SST8 to the fifth zone ZONE5, excluding the third SST SST3(INV) and the invalid SST SST_INV from the data stored in the third zone ZONE3 during the garbage collection operation. In some implementations, after performing the garbage collection operation for the third zone ZONE3, the zone management controller 2300 can provide a zone reset command to the storage device 1000 to erase the data stored in the third zone ZONE3.

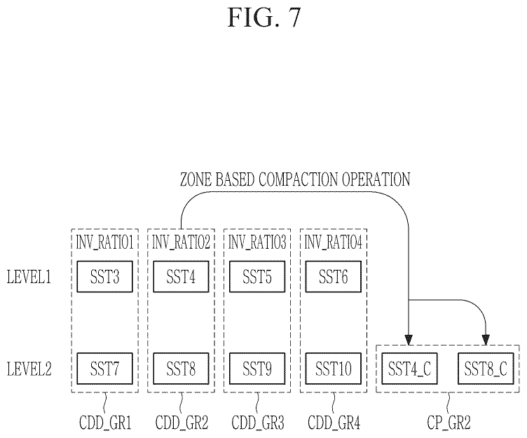

FIG. 7 is a diagram illustrating an example of a zone-based compression operation.

Referring to FIGS. 4 and 7, the compression controller 2200 can perform zone-based compression operation if the size of the free space in the storage device 1000 is less than or equal to a preset size.

In some implementations, the compression controller 2200 can determine a first level SST group GR_LV1 of a size larger than a first threshold size SIZE_TR1 among multiple SSTs level groups.

In some implementations, the compression controller 2200 can determine overlapping SSTs that include keys overlapping with the keys included in the third to sixth SST SST3~SST6 in the first level SST group GR_LV1. In some implementations, the compression controller 2200 can determine the overlapping SST of the third SST SST3 as the seventh SST SST7 and the overlapping SST of the fourth SST SST4 as the eighth SST SST8.

In some implementations, the compression controller 2200 can determine a plurality of compression candidate groups CDD_GR1~CDD_GR4 including the third to sixth SST SST3~SST6 and the seventh to tenth SST SST7~SST10 included in the first level SST group GR_LV1.

In some implementations, the compression controller 2200 can select a compression candidate group from among multiple compression candidate groups to perform zone-based compression operation based on the invalidation rate of zones in which each of the multiple compression candidate groups is stored.

In some implementations, the compression controller 2200 can determine the invalidation rates of zones where the first to fourth compression candidate groups CDD_GR1~CDD_GR4 are stored as the first to fourth invalidation ratios INV_RATIO1~INV_RATIO4, respectively. In some implementations, the compression controller 2200 can select a compression candidate group to perform zone-based compression operation based on the result of comparing the first to fourth invalidation ratios INV_RATIO1~INV_RATIO4.

In some implementations, a second invalidation ratio INV_RATIO2 among the first to fourth invalidation ratios INV_RATIO1~INV_RATIO4 can be the highest. In some implementations, the compression controller 2200 can select the second compression candidate group CDD_GR2, which is stored in the zones with the highest second invalidation ratio INV_RATIO2 among the first to fourth invalidation ratios INV_RATIO1~INV_RATIO4, as the compression candidate group to perform zone-based compression operations.

In some implementations, the compression controller 2200 can perform zone-based compression operations on the second compression candidate group CDD_GR2, which is determined based on the invalidation rates of the zones where the first to fourth compression candidate groups CDD_GR1~CDD_GR4 are stored.

In some implementations, the compression controller 2200 can generate a fourth compression SST SST4_C and a eighth compression SST SST8_C by excluding duplicate keys from the keys included in the fourth SST SST4 and the eighth SST SST8. In some implementations, the compression controller 2200 can provide the fourth compression SST SST4_C and the eighth compression SST SST8_C to the storage device 1000.

In some implementations, the level of the second compression group (CP_GR2), which includes the fourth compression SST SST4_C and the eighth compression SST SST8_C, can correspond to the second level LEVEL2. The fourth compression SST SST4_C and the eighth compression SST SST8_C can be included in the second level SST group GR_LV2.

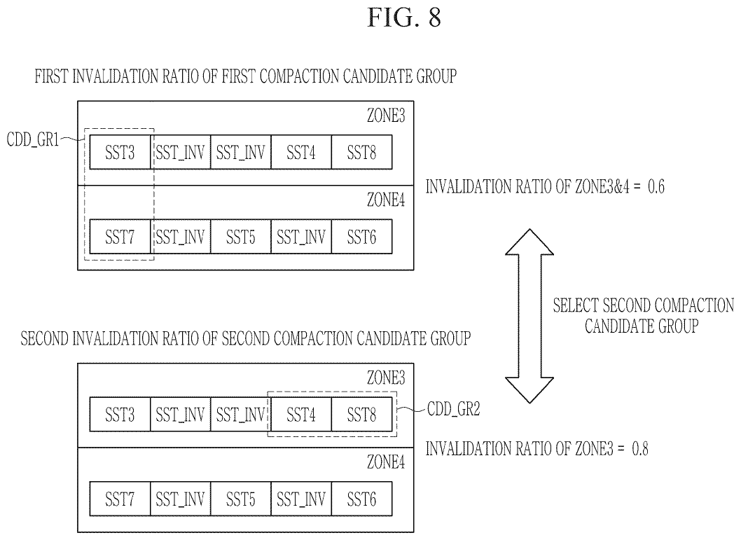

FIG. 8 is a diagram illustrating an example of a host that can select one of compression candidate groups based on invalidation rates of a plurality of zones.

Referring to FIGS. 7 and 8, Zone 3 ZONE3 can store the third SST SST3, invalid SST SST_INV, fourth SST SST4, and eighth SST SST8. In some implementations, the fourth zone ZONE4 can store the seventh SST SST7, invalid SST SST_INV, fifth SST SST5, and sixth SST SST6.

In some implementations, if the size of the free space in the storage device 1000 is less than or equal to a preset size, the compression controller 2200 can determine the compression candidate group to perform zone-based compression operation based on the comparison result of the first invalidation ratio INV_RATIO1 of the third zone ZONE3 and the fourth zone ZONE4 where the first compression candidate group CDD_GR1 is stored, and the second invalidation ratio INV_RATIO2 of the third zone ZONE3 where the second compression candidate group CDD_GR2 is stored.

In some implementations, the compression controller 2200 can determine the size of the zones where one compression candidate group is stored, based on the invalidation rate of the zones where the compression candidate group is stored, in relation to the size of the invalid SST SST_INV stored in those zones and the sum of the sizes of the SSTs included in the compression candidate group.

In some implementations, the compression controller 2200 can determine the size of the third zone ZONE3 and the fourth zone ZONE4 in relation to the sum of the size of the third SST SST3, the size of the seventh SST SST7, and the size of the invalid SST SST_INV as the first invalidation ratio INV_RATIO1 of the third zone ZONE3 and the fourth zone ZONE4 where the first compression candidate group CDD_GR1 is stored. In some implementations, assuming each SST has a size of “1” and each zone has a size of “5”, the first invalidation ratio INV_RATIO1 of the third zone ZONE3 and the fourth zone ZONE4 where the first compression candidate group CDD_GR1 is stored can be “0.6”.

In some implementations, the compression controller 2200 can determine the size of the third zone ZONE3 relative to the sum of the size of the invalid SST SST_INV stored in the third zone ZONE3, the size of the fourth SST SST4, and the size of the eighth SST SST8, as the second invalidation ratio INV_RATIO2 of the third zone ZONE3 where the second compression candidate group CDD_GR2 is stored. In some implementations, if the size of each SST is “1” and the size of each zone is “5”, for example, the second invalidation ratio INV_RATIO2 of the third zone ZONE3 where the second compression candidate group CDD_GR2 is stored can be “0.8”.

In some implementations, the compression controller 2200 can select the second compression candidate group CDD_GR2, which has a higher invalidation ratio, as the compression candidate group to perform the zone-based compression operation between the first invalidation ratio INV_RATIO1 of the first compression candidate group CDD_GR1 and the second invalidation ratio INV_RATIO2 of the second compression candidate group CDD_GR2. Similarly, the compression controller 2200 can select the second compression candidate group CDD_GR2 as the compression candidate group to perform the zone-based compression operation if the second invalidation ratio INV_RATIO2 of the second compression candidate group CDD_GR2 is higher than the third invalidation ratio INV_RATIO3 of a third compression candidate group CDD_GR3 and a fourth invalidation ratio INV_RATIO4 of the fourth compression candidate group CDD_GR4.

In some implementations, the third SST SST3 and the seventh SST SST7 included in the first compression candidate group CDD_GR1 can be stored in different zones, and the fourth SST SST4 and the eighth SST SST8 included in the second compression candidate group CDD_GR2 can be stored in the same zone.

In some implementations, the more SSTs stored in the same zone among the SSTs included in one compression candidate group, the higher the invalidation rate of the zones where one compression candidate group is stored can be.

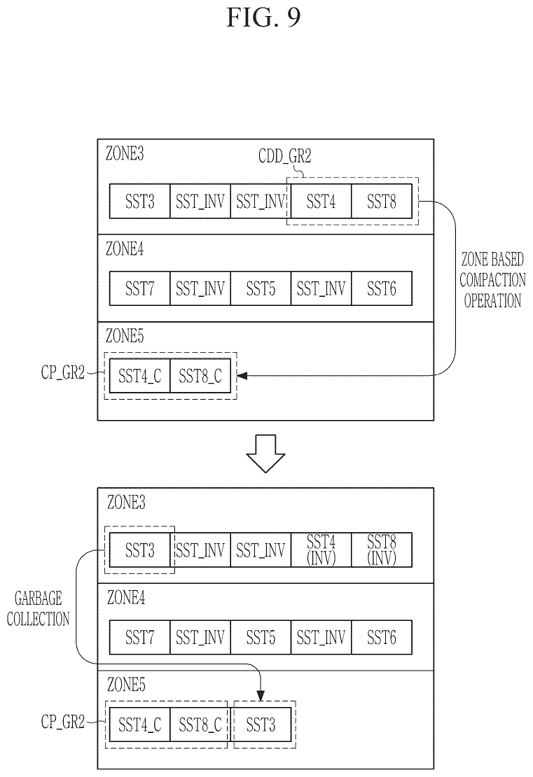

FIG. 9 is a diagram illustrating an example of a garbage collection operation that can be conducted according to a zone-based compression.

Referring to FIGS. 7, 8, and 9, if the size of the free space in the storage device 1000 is less than or equal to a preset size, the compression controller 2200 can select a second compression candidate group CDD_GR2 based on the invalidation rate of zones where multiple compression candidate groups are stored. This second compression candidate group CDD_GR2 includes the fourth SST SST4 and the eighth SST SST8, and a zone-based compression operation can be performed on it.

In some implementations, the compression controller 2200 can generate fourth compression SST SST4_C and eighth compression SST SST8_C by compressing the fourth SST SST4 and the eighth SST SST8 stored in the third zone ZONE3 while performing zone-based compression operations, and store the fourth compression SST SST4_C and eighth compression SST SST8_C in the fifth zone ZONE5.

In some implementations, after the zone management controller 2300 performs zone-based compression operations on the second compression candidate group CDD_GR2, it can set the fourth SST SST4 and the eighth SST SST8 stored in the third zone ZONE3 as invalid data INV. In some implementations, after the fourth SST SST4 and the eighth SST SST8 are set as invalid data, the zone management controller 2300 can perform a garbage collection operation on the third zone ZONE3. In some implementations, the valid data stored in the third zone ZONE3 can be the third SST SST3.

In some implementations, the zone management controller 2300 can copy the third SST SST3 to the fifth zone ZONE5, excluding the invalid SST SST_INV, the fourth SST SST4(INV), and the eighth SST SST8(INV) from the data stored in the third zone ZONE3 during the garbage collection operation.

In some implementations, the zone-based compression operation can reduce the size of valid data that needs to be copied from the zone where the compression candidate group is stored during the garbage collection operation compared to the size-based compression operation.

In some implementations, after the zone-based compression operation for the second compression candidate group CDD_GR2 is performed, the valid data to be copied from the third zone ZONE3 where the second compression candidate group CDD_GR2 is stored during the garbage collection operation can be one as the third SST SST3.

In some implementations, as described with reference to FIG. 6, after the size-based compression operation for the first compression candidate group CDD_GR1 is performed, the valid data to be copied from the third zone ZONE3, where the first compression candidate group CDD_GR1 is stored, during the garbage collection operation, can be the fourth SST SST4 and the eighth SST SST8.

In some implementations, after the zone-based compression operation is performed, the size of the valid data to be copied in the garbage collection operation can be smaller than the size of the valid data to be copied in the garbage collection operation after the size-based compression operation is performed. If the size of the valid data to be copied in the garbage collection operation is reduced, the time taken for the garbage collection operation can decrease.

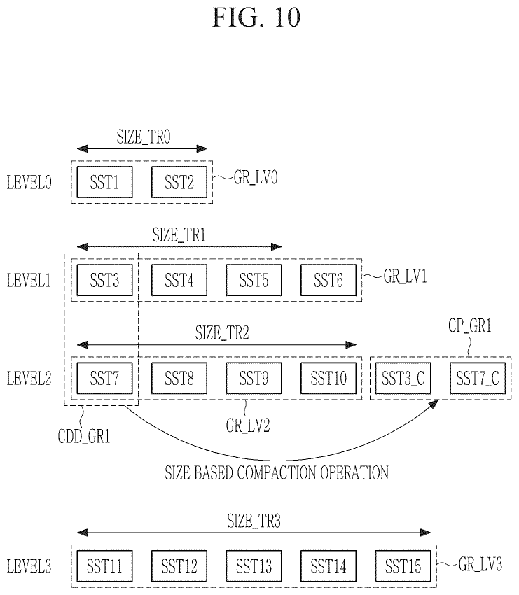

FIG. 10 is a diagram illustrating an example of a host that can perform size-based compression operations based on a level of an SST level group being greater than a threshold size.

Referring to FIG. 10, the compression controller 2200 can determine a target level SST group with a size larger than the threshold size among multiple SSTs level group GR_LV0~GR_LV3. In some implementations, the compression controller 2200 can perform size-based compression operations or zone-based compression operations based on the level of the target level SST group.

In some implementations, the compression controller 2200 can perform size-based compression operation if the level of the target level SST group is less than or equal to the threshold level. In some implementations, the threshold level can be the first level LEVEL1.

In some implementations, the compression controller 2200 determines the first level SST group GR_LV1 with a size larger than the first threshold size SIZE_TR1 among multiple SSTs level groups as the target level SST group. If the first level LEVEL1 of the first level SST group GR_LV1 is equal to or lower than the threshold level, a size-based compression operation can be performed.

In some implementations, the compression controller 2200 can determine the third SST SST3, which is the largest among the third to sixth SST SST3~SST6 included in the first level SST group GR_LV1. In some implementations, the compression controller 2200 can determine the seventh SST SST7, which includes keys overlapping with the keys included in the third SST SST3, as the overlapping SST. In some implementations, the compression controller 2200 can determine the first compression candidate group CDD_GR1, which includes the third SST SST3 and the seventh SST SST7, as the compression candidate group to perform the size-based compression operation.

In some implementations, the compression controller 2200 can generate a compressed third SST SST3_C and a compressed seventh SST SST7_C by compressing the third SST SST3 and the seventh SST SST7 while performing size-based compression operations on the first compression candidate group CDD_GR1.

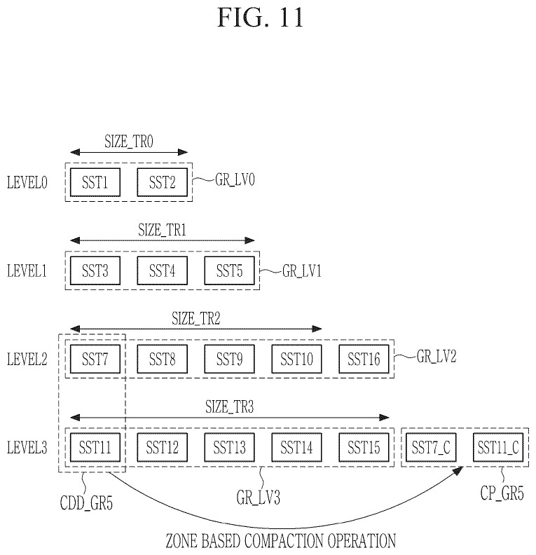

FIG. 11 is a diagram illustrating an example of a host that can perform zone-based compression operations based on a level of an SST level group being greater than a critical size.

Referring to FIG. 11, the compression controller 2200 determines a target level SST group with a size larger than the threshold size among multiple SSTs level group GR_LV0~GR_LV3, and if the level of the target level SST group is higher than the threshold level, it can perform zone-based compression operations.

In some implementations, when performing zone-based compression operations on a target level SST group with a level lower than the threshold level, the timing of subsequent compression operations can be delayed, which can result in an increase in the time required to perform the overall compression operation.

In some implementations, the compression controller 2200 determines the second level SST group GR_LV2 with a size larger than the second threshold size SIZE_TR2 among multiple SSTs level group GR_LV0~GR_LV3 as the target level SST group. If the second level LEVEL2 of the second level SST group GR_LV2 is higher than the threshold level, a zone-based compression operation can be performed.

In some implementations, the compression controller 2200 can determine the overlapping SST SST11~SST15 of the third level SST group GR_LV3, which includes keys that overlap with the keys of a target SST SST7~SST10, SST16 included in the second level SST group GR_LV2, and decide on multiple compression candidate groups that include the target SST SST7~SST10, SST16 of the second level SST group GR_LV2 and the overlapping SST SST11~SST15 of the third level SST group GR_LV3.

In some implementations, the compression controller 2200 determines the invalidation rates of zones where multiple compression candidate groups are stored and can select the fifth compression candidate group CDD_GR5, stored in the zones with the highest invalidation rates among the multiple compression candidate groups, as the compression candidate group on which to perform the zone-based compression operation. In some implementations, while performing the zone-based compression operation on the fifth compression candidate group CDD_GR5, the compression controller 2200 can generate the fifth compression group CP_GR5, which includes the seventh compression SST SST7_C and eleventh compression SST SST11_C, obtained by compressing the seventh SST SST7 and the eleventh SST SST11. The fifth compression group CP_GR5 can be included in the third level SST group GR_LV3.

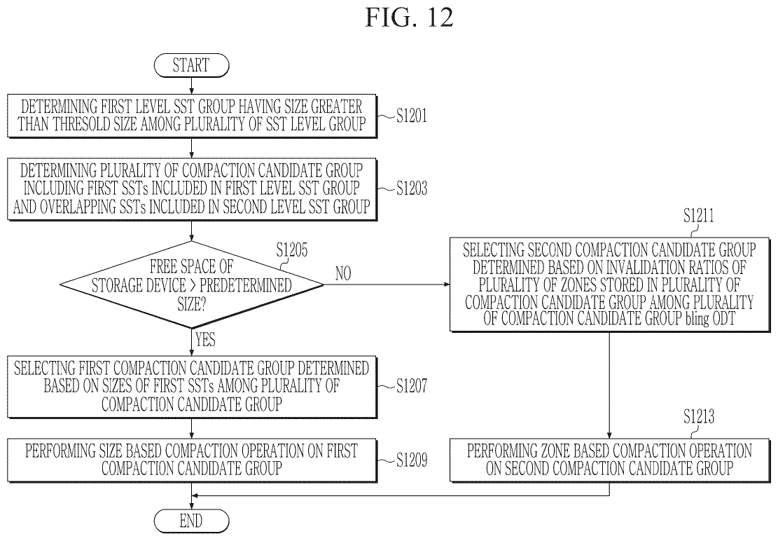

FIG. 12 is a flowchart of an example of an electronic system that can perform size-based compression operation or zone-based compression operation.

Referring to FIG. 12, in S1201, the host device 2000 can determine a first level SST group of a size larger than the threshold size among multiple SSTs level groups.

In S1203, the host device 2000 can determine a plurality of compression candidate groups including first SSTs included in a first-level SST level group and nested SSTs included in a second-level SST level group. In some implementations, the level of the second-level SST level group can be higher than the level of the first-level SST level group. The nested SSTs can include keys that overlap with keys included in the first SSTs.

In S1205, the host device 2000 can determine whether the free space of the storage device 1000 is greater than a preset size. In some implementations, if the free space of the storage device 1000 is greater than the preset size, S1207 can be performed. In some implementations, if the free space of the storage device 1000 is less than or equal to the preset size, S1211 can be performed.

In S1207, if the free space of the storage device 1000 is greater than a preset size, the host device 2000 can select a first compression candidate group determined based on the sizes of first SSTs included in a first level SST group among multiple compression candidate groups. In some implementations, the first compression candidate group can include the SST with the largest size among the first SSTs.

In S1209, the host device 2000 can perform a size-based compression operation on the first compression candidate group.

In S1211, if the free space of the storage device 1000 is less than or equal to a preset size, the host device 2000 can select a second compression candidate group, determined based on the invalidation rate of zones where multiple compression candidate groups are stored, from among the multiple compression candidate groups. In some implementations, the host device 2000 can determine the invalidation rate of zones where one compression candidate group is stored by comparing the size of invalid SSTs stored in the zones with the sum of the sizes of SSTs included in one compression candidate group. In this implementation, the invalidation rate of zones where the second compression candidate group is stored can be higher than the invalidation rates of zones where the remaining compression candidate groups are stored.

In S1213, the host device 2000 can perform zone-based compression operations for the second compression candidate group.

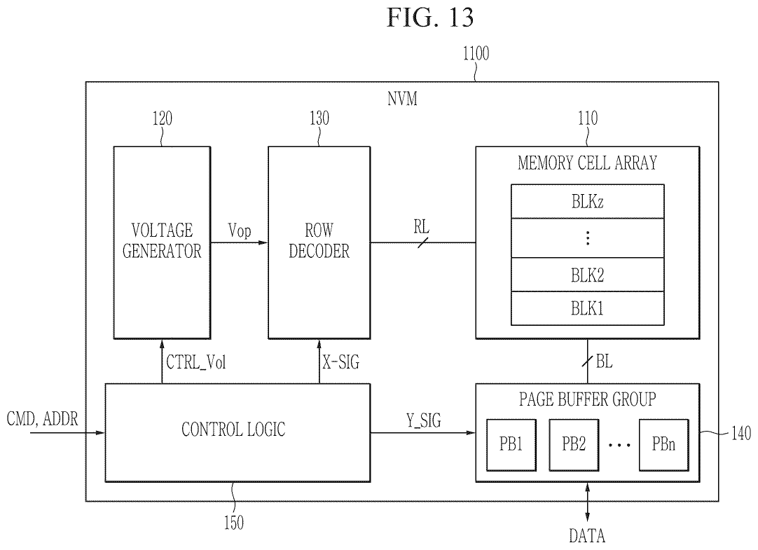

FIG. 13 is a diagram illustrating an example of a non-volatile memory device.

Referring to FIG. 13, the non-volatile memory device 1100 can include a memory cell array 110, a voltage generator 120, a row decoder 130, a page buffer group 140, and a control logic 150.

The memory cell array 110 can include a plurality of memory blocks BLK1~BLKz. The plurality of memory blocks BLK1~BLKz can be connected to the row decoder 130 through row lines RL. The plurality of memory blocks BLK1~BLKz can be connected to the page buffer group 140 through bit lines BL. Each of the plurality of memory blocks BLK1~BLKz can include a plurality of memory cells. In some implementations, the plurality of memory cells can be non-volatile memory cells. In some implementations, the plurality of memory blocks BLK1~BLKz can include invalid memory blocks where invalid data is stored, valid memory blocks where valid data is stored, off blocks where data is partially stored, and erased memory blocks where no data is stored.

The voltage generator 120 can generate operating voltages Vop using the external power supply voltage provided to the non-volatile memory device 1100. The voltage generator 120 can operate in response to the control of the control logic 150.

In some implementations, the voltage generator 120 can generate operating voltages Vop used in program operations, read operations, and erase operations. For example, the voltage generator 120 can generate a program voltage, pass voltage, read voltage, and erase voltage. The operating voltages Vop can be supplied to the memory cell array 110 by the row decoder 130.

The row decoder 130 can be connected to the memory cell array 110 through row lines RL. The row lines RL can include string select lines, word lines, and ground select lines.

The row decoder 130 can operate in response to the control of the control logic 150. The row decoder 130 can receive a row signal X_SIG from the control logic 150. In some implementations, the row decoder 130 selects at least one word line from among a plurality of word lines based on the row signal X_SIG, and can apply the operating voltages Vop provided from the voltage generator 120 to at least one word line.

In some implementations, the row decoder 130 can apply a program voltage to the selected word line among multiple word lines during a program operation and apply a pass voltage lower than the program voltage to the unselected word lines. During a program verification operation, the row decoder 130 can apply a verification voltage to the selected word line and apply a verification pass voltage higher than the verification voltage to the unselected word lines.

The row decoder 130 can apply a read voltage to the selected word line during a read operation and apply a read pass voltage, which is at a higher level than the read voltage, to the unselected word lines.

The page buffer group 140 can include a plurality of page buffers PB1~PBn. The plurality of page buffers PB1~PBn can each be connected to a plurality of memory cells included in the memory cell array 110 through bit lines BL. The plurality of page buffers PB1~PBn can operate in response to the control of the control logic 150.

In some implementations, multiple page buffers PB1~PBn can receive data DATA from the storage controller 1200. The multiple page buffers PB1~PBn can select at least one of the bitlines BL based on the column signal Y_SIG received from the control logic 150.

In some implementations, multiple page buffers PB1~PBn can transfer data received from the storage controller 1200 to multiple memory cells of the memory cell array 110 through bit lines BL during a program operation. The multiple memory cells can be programmed according to the received data. During a program verification operation, the multiple page buffers PB1~PBn can sense the data stored in the multiple memory cells through the bit lines BL.

Multiple page buffers PB1~PBn can sense the data stored in memory cells through bit lines BL during the read operation and store the sensed data in multiple page buffers PB1~PBn.

The control logic 150 can be connected to the voltage generator 120, the row decoder 130, and the page buffer group 140.

The control logic 150 can control the overall operation of the non-volatile memory device 1100. In response to commands received from the storage controller 1200, the control logic 150 can control the voltage generator 120, row decoder 130, and page buffer group 140 to perform operations corresponding to the commands.

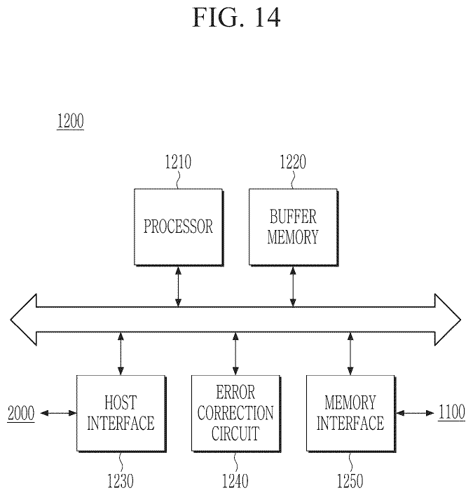

FIG. 14 is a diagram illustrating an example of a storage controller.

Referring to FIG. 14, the storage controller 1200 can include a processor 1210, buffer memory 1220, host interface 1230, error correction circuit 1240, and memory interface 1250.

In some implementations, the processor 1210 can control the overall operation of the storage controller 1200. The processor 1210 can control the program operation according to the write request from the host device 2000 and the read operation according to the read request from the host device 2000.

In some implementations, the processor 1210 can read SSTs stored in the non-volatile memory device and provide the SSTs received from the non-volatile memory device to the host device 2000. In some implementations, the processor 1210 can store SSTs or compressed SSTs received from the host device 2000 in the non-volatile memory device.

In some implementations, the buffer memory 1220 can be used as a cache memory or an operational memory of the storage controller 1200.

In some implementations, the buffer memory 1220 can temporarily store data provided from the host device 2000 or data read from the non-volatile memory device 1100. In some implementations, the buffer memory 1220 can be a Dynamic Random Access Memory (DRAM) or a Static Random Access Memory (SRAM). In some implementations, the buffer memory 1220 can temporarily store SSTs or compressed SSTs.

In some implementations, the host interface 1230 can communicate with the host device 2000. The host interface 1230 can receive requests or data from the host device 2000 or provide responses or data to requests to the host device 2000.

In some implementations, the error correction circuit 1240 can perform an encoding operation to generate parity data for data received from the host device 2000. The encoded data can be provided to the non-volatile memory device 1100 through the memory interface 1250. The error correction circuit 1240 can perform an error correction operation on data read from the non-volatile memory device 1100. The error correction circuit 1240 can correct error bits contained in the data read from the non-volatile memory device 1100 by performing an error correction operation. The error correction circuit 1240 can provide the error-corrected data to the host device 2000 through the host interface 1230.

In some implementations, the memory interface 1250 can communicate with the non-volatile memory device 1100. The memory interface 1250 can provide commands or data to the non-volatile memory device 1100 or receive data from the non-volatile memory device 1100.

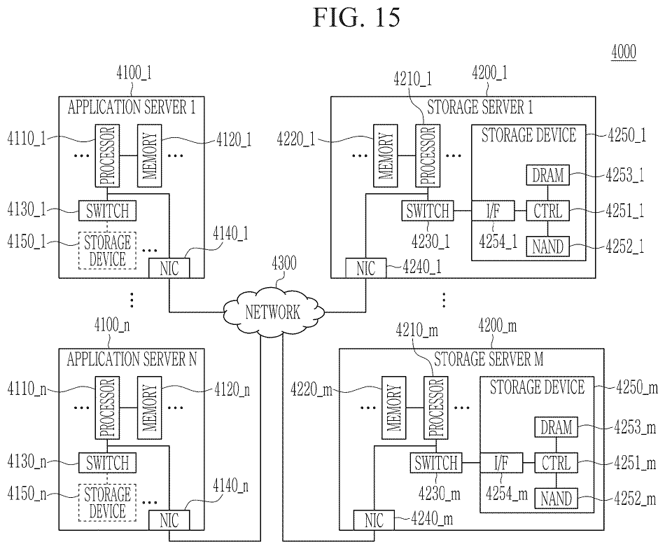

FIG. 15 is a diagram illustrating an example of a system that includes a storage device.

Referring to FIG. 15, a data center 4000 is a facility that collects various data and provides services, and it can also be referred to as a data storage center. The data center 4000 can be a system for operating search engines and databases, or it can be a computing system used by enterprises such as banks or government agencies.

In some implementations, the data center 4000 can include application servers 4100_1 to 4100_n and storage servers 4200_1 to 4200_m. The number of application servers 4100_1 to 4100_n and the number of storage servers 4200_1 to 4200_m can be variously selected according to the implementation, and the number of application servers 4100_1 to 4100_n and the number of storage servers 4200_1 to 4200_m can differ from each other.

In some implementations, the application server 4100 or storage server 4200 can include at least one of a processor 4110, 4210 and memory 4120, 4220. Describing the storage server 4200 as an example, the processor 4210 can control the overall operation of the storage server 4200 and access the memory 4220 to execute instructions and/or data loaded in the memory 4220. The memory 4220 can be DDR SDRAM (Double Data Rate Synchronous DRAM), HBM (High Bandwidth Memory), HMC (Hybrid Memory Cube), DIMM (Dual In-line Memory Module), Optane DIMM, and/or NVMDIMM (Non-Volatile DIMM). Depending on the implementation, the number of processors 4210 and the number of memory 4220 included in the storage server 4200 can be variously selected.

In some implementations, the processor 4110, 4210 can generate multiple key-value pairs. In some implementations, the processor 4110, 4210 can generate multiple SSTs that are sorted based on keys. In some implementations, the processor 4110, 4210 can provide multiple SSTs to the storage device 4150, 4250. In some implementations, the processor 4110, 4210 can perform size-based compression operations or zone-based compression operations on multiple SSTs based on the free space of the storage device 4150, 4250. In some implementations, the processor 4110, 4210 can perform size-based compression operations or zone-based compression operations on multiple SSTs based on the level of a target level SST group that is larger than the threshold size among multiple SSTs level groups.

In some implementations, the processor 4210 and memory 4220 can provide a processor-memory pair. In some implementations, the number of processors 4210 and memory 4220 can differ from each other. The processor 4210 can include a single-core processor or a multi-core processor. The description for the storage server 4200 can similarly be applied to the application server 4100. Depending on the implementation, the application server 4100 may not include a storage device 4150. The storage server 4200 can include at least one or more storage devices 4250. The number of storage devices 4250 included in the storage server 4200 can be variously selected depending on the implementation.

The implementations of the present invention have been described in detail above, but the scope of the present invention is not limited thereto, and various modifications and improvements by those skilled in the art using the basic concept of the present invention defined in the following claims also fall within the scope of the present invention.

What is claimed is:

1. An electronic system comprising:
a storage device including a plurality of zones configured to store a plurality of sorted string tables (SSTs); and
a host configured to
determine, among the plurality of SSTs, (i) a first compression candidate group including a first SST and a first overlapping SST that shares one or more keys with the first SST and (ii) a second compression candidate group including a second SST and a second overlapping SST that shares one or more keys with the second SST, and
perform at least one of
a zone-based compression operation on the first compression candidate group, wherein the first compression candidate group, among the first compression candidate group and the second compression candidate group, is subject to the zone-based compression operation based on (i) invalidation rates of zones that store the first and second compression candidate groups and (ii) free space of the storage device, or
size-based compression operation on the second compression candidate group, wherein the second compression candidate group, among the first compression candidate group and the second compression candidate group, is subject to the size-based compression operation based on sizes of the first SST and the second SST.

2. The electronic system of claim 1, wherein the host is configured to:
perform, based on a size of the free space of the storage device being less than a preset size, the zone-based compression operation on the first compression candidate group; and
provide, to the storage device, a first compressed SST resulting from compressing the first SST and the first overlapping SST.

3. The electronic system of claim 1, wherein the host configured to:
perform, based on comparing (i) an invalidation rate of a first zone that stores the first compression candidate group and (ii) an invalidation rate of a second zone that stores the second compression candidate group, the zone-based compression operation on the first compression candidate group.

4. The electronic system of claim 3, wherein the invalidation rate of the first zone is greater than the invalidation rate of the second zone.

5. The electronic system of claim 3, wherein the host is configured to:
determine, based on a size of the first zone, the invalidation rate of the first zone, wherein the size of the first zone is based on at least a sum of the sizes of (i) a first invalid SST, (ii) the first SST, and (iii) the first overlapping SST; and
determine, based on a size of the second zone, the invalidation rate of the second zone, wherein the size of the second zone is based on at least a sum of sizes of (i) a second invalid SST, (ii) the second SST, and (iii) the second overlapping SST.

6. The electronic system of claim 5, wherein the host is configured to:
copy first valid SSTs that exclude (i) the first invalid SST, (ii) the first SST, and (iii) the first overlapping SST, from the first zone to a third zone, after performing the zone-based compression operation,
wherein the host includes a zone management controller that is configured to copy second valid SSTs that exclude (i) the second invalid SST, (ii) the second SST, and (iii) the second overlapping SST, from the second zone to the third zone, after performing the size-based compression operation, and
wherein a size of the first valid SSTs is less than a size of the second valid SSTs.

7. The electronic system of claim 1, wherein the host is configured to:
perform, based a size of the free space in the storage device being greater than a preset size, the size-based compression operation on the second compression candidate group; and
provide second compressed SSTs that comprise compressed second SST and compressed second overlapping SST to the storage device.

8. The electronic system of claim 7, wherein the host is configured to:
perform, based on a determination that a size of the second SST is greater than a size of the first SST, the size-based compression operation on the second compression candidate group.

9. The electronic system of claim 1, wherein the first SST and the first overlapping SST included in the first compression candidate group are stored in one zone, and the second SST and the second overlapping SST included in the second compression candidate group are stored in a different zone.

10. The electronic system of claim 1, wherein the storage device is configured to store a plurality of SST level groups, each including a plurality of SSTs,
wherein the host is configured to determine a first level SST group that has a size greater than a threshold size among the plurality of SST level groups, and
wherein the first level SST group comprises the first SST and the second SST.

11. The electronic system of claim 10, wherein the first overlapping SST and the second overlapping SST are included in a second level SST group among the plurality of SST level groups, and
wherein the first overlapping SST or the second overlapping SST includes one or more keys that overlap with one or more keys included in the first SST or the second SST.

12. An electronic system comprising:
a storage device including a plurality of zones configured to store a plurality of sorted string table (SST) level groups including a plurality of SSTs; and
a host configured to
determine a first SST level group that has a size greater than a threshold size among the plurality of SST level groups,
determine, among the plurality of SST level groups, a plurality of compression candidate groups including (i) first SSTs of the first SST level group and (ii) overlapping SSTs of a second SST level group, and
perform at least one of
a zone-based compression operation on a first compression candidate group, wherein the first compression candidate group, among the plurality of compression candidate groups, is subject to the zone-based compression operation based on invalidation rates of zones that store the plurality of compression candidate groups, or
a size-based compression operation on a second compression candidate group, wherein the second compression candidate group, among the plurality of compression candidate groups, is subject to the size-based compression operation based on sizes of the first SSTs.

13. The electronic system of claim 12, wherein the host is configured to:
perform, based on a level of the first SST level group being higher than a threshold level, the zone-based compression operation on a first compression candidate SST group.

14. The electronic system of claim 12, wherein the host is configured to:
determine, based on a level of the first SST level group being higher than a threshold level, a compression candidate group that (i) is stored in a first zone and (ii) has a highest invalidation rate among invalidation rates of the plurality of zones storing the plurality of compression candidate groups, as the first compression candidate group.

15. The electronic system of claim 12, wherein the host is configured to:
determine, based on a size of a compression candidate group and a sum of sizes of invalid SSTs stored in zones that store the compression candidate group, a size of a zone that stores the compression candidate group by using an invalidation rate of the zone that stores the compression candidate group.

16. The electronic system of claim 12, wherein the host is configured to:
perform, based on a level of the first SST level group being lower than a threshold level, the size-based compression operation on the second compression candidate group.

17. The electronic system of claim 12, wherein the host is configured to:
determine, based on a level of the first SST level group being lower than a threshold level, a compression candidate group that includes (i) a target SST having a largest size among the first SSTs and (ii) a target overlapping SST including one or more keys that overlap with one or more keys included in the target SST among overlapping SSTs, as the second compression candidate group.

18. A method of compressing sorted string table (SST) comprising:
determining a first SST level group that has a size greater than a threshold size among a plurality of SST level groups including a plurality of SSTs;
determining a plurality of compression candidate groups including first SSTs of the first SST level group and overlapping SSTs of a second SST level group among a plurality of SST level groups;
determining (i) a first compression candidate group based on invalidation ratios of a plurality of zones that store the plurality of compression candidate groups, or (ii) a second compression candidate group based on a size of the first SSTs among the plurality of compression candidate groups and a free space of a storage device; and
performing a compression operation on the first compression candidate group or the second compression candidate group based on the free space of the storage device.

19. The method of compressing SST of claim 18, wherein performing the compression operation on the first compression candidate group or the second compression candidate group includes:
performing the compression operation on the first compression candidate group based on a determination that the size of the free space of the storage device is less than a preset size.

20. The method of compressing SST of claim 18, wherein the first compression candidate group and the second compression candidate group are stored in the plurality of zones including a first zone and a second zone, and
wherein determining the first compression candidate group or the second compression candidate group includes:
determining the first compression candidate group based on a determination that (i) the size of the free space of the storage device is less than a preset size and (ii) an invalidation rate of the first zone is greater than an invalidation rate of the second zone.
